(19) United States
(12) Patent Application Publication
(10) Pub. No.: US 2006/0149895 A1
(43) Pub. Date: Jul. 6, 2006

(54) Flash memory with integrated male and female connectors and wireless capability

(76) Inventor: Alan L. Pocrass, Simi Valley, CA (US)

Correspondence Address: THE WEBB LAW FIRM, P.C., 700 KOPPERS BUILDING, 436 SEVENTH AVENUE, PITTSBURGH, PA, 15219, US

(21) Appl. No.: 11/324,722

(22) Filed: Jan. 3, 2006

Related U.S. Application Data
(60) Provisional application No. 60/641,872, filed on Jan. 4, 2005.

(51) Int. Cl. G06F 12/00

(52) U.S. Cl. 711/103; 711/115

(57) ABSTRACT

A handheld, portable flash memory drive includes a flash memory chip, a controller for controlling the transfer of data to or from the flash memory chip, and a wireless communication chip for establishing a direct radio communication link with another flash memory drive for radio transmitting data from the flash memory chip to the other flash memory drive, or vice versa, under the control of the controller. An enclosure houses the flash memory chip, the controller, and the wireless communication chip. The drive can also include a male or female USB connector that can be mated with a female or male USB connector, respectively, of another flash memory drive for transferring data from the flash memory chip to the other flash memory drive, or vice versa, via the mated connectors under the control of the controller.

### CROSS REFERENCE TO RELATED APPLICATIONS

This application claims priority from U.S. Provisional Patent Application No. 60/641,872, filed Jan. 4, 2005, which is incorporated herein by reference.

### BACKGROUND OF THE INVENTION

1. Field of the Invention

The present invention relates to a flash memory drive and, more particularly, to a flash memory drive with integrated male and female connectors with the capability to communicate together and with other flash memory drives by a direct connection or through a wireless connection.

2. Description of Related Art

Flash memory drives are typically non-mechanical devices that can currently hold from 256 kilobytes to 1 gigabyte of data. A flash memory drive, such as a compact flash drive, connects to a computer via a Universal Serial Bus (USB) connector and can transfer data at rates of more than 1 MB per second. Current flash memory drives have male USB connectors that plug into female USB ports on a desktop computer, a laptop computer or a palm device. An advantage of a flash memory device is that it is small, portable, tough and has a large memory capacity. A typical flash memory drive is about the size and weight of a disposable lighter or a pack of gum. It can also be worn around a user's neck, attached to a key chain or easily fit into a handbag.

Currently flash memory devices do not include any means for transferring information between two flash memory devices without the use of a computer or a palm device. This limits the file sharing capabilities of such devices. Furthermore, the use of such devices limits the number of available USB ports on a computer that may be needed for printers, digital cameras, scanners and the like.

Accordingly, a need exists for a flash memory drive that can transfer data to another flash memory drive without the use of a computer. A further need exists for a flash memory drive that enables devices with male USB connectors to be plugged into the flash memory drive. A further need exists for a flash memory drive with wireless capability to transfer data from one flash memory drive to another with a wireless connection. The most common wireless protocols are Bluetooth and WiFi wireless connectivity.

### SUMMARY OF THE INVENTION

The invention is a flash memory drive comprising a flash memory chip for storing data, a male connector and a female connector having a form factor that can mate with the male connector. The drive also includes means for controlling the transfer of data to or from the flash memory chip and means for establishing a direct wireless communication link with an external device, such as, without limitation, another flash memory drive. The female connector is configured to mate with another male connector like the male connector of the drive and the male connector is configured to mate with another female connector like the female connector of the drive. The male and female connectors are each configured to pass data to and/or from the flash memory chip under the control of the means for controlling the transfer of data when said connector is mated to a mating connector. The means for establishing a wireless communication link wirelessly transmits data directly to the external device from the flash memory chip and/or wirelessly receives data directly from the external device for storage in the flash memory chip under the control of the means for controlling the transfer of data when neither the male connector nor the female connector is mated to a mating connector.

The drive can include an enclosure surrounding the flash memory chip, the means for controlling the transfer of data and the means for establishing a wireless communication link.

The drive can also include at least one of a battery coupled to provide power to the flash memory chip, the means for controlling the transfer of data and the means for establishing a wireless communication link, a switch for causing the transfer of data to or from the flash memory chip, a master/slave switch for setting the drive to transfer data to or from the flash memory chip as a function of the setting of said master/slave switch, and an LED for indicating that the transfer of data is in progress.

The drive can also include means for retrieving digital audio data from the flash memory chip, means for decoding the retrieved digital audio data, means for converting the decoded digital audio data to an analog signal, and an output connector for outputting the analog signal.

The enclosure can also surround at least one of the means for retrieving digital audio data, the means for decoding the retrieved digital audio data, the means for converting the decoded digital audio data to an analog signal and at least part of the output connector. A plurality of buttons can be accessible via the enclosure for controlling at least one of the means for retrieving digital audio data, the means for decoding the retrieved digital audio data and the means for converting the decoded digital audio data to an analog signal.

A display screen viewable via the enclosure for providing a visual indication of information related to the digital audio data can also be provided.

The invention is also a method of transferring data from a first flash memory drive having an integrated male connector to a second flash memory drive having an integrated female connector configured to mate with the male connector, wherein each flash memory drive has wireless communication capability. The method includes, when the female connector is not mated with the male connector, creating a wireless communication link directly between the first flash memory drive and the second flash memory drive and wirelessly transferring data from the flash memory chip of the first flash memory drive to the flash memory chip of the second flash memory drive, or vice versa. When the female connector is mated with the male connector, the method includes, transferring data from the flash memory chip of the first flash memory drive to the flash memory chip of the second flash memory drive, or vice versa, via the mated connectors.

The first flash memory drive can include a master/slave switch set to one of a master position and a slave position and the second flash memory drive can include a master/slave switch set to the other of the master position and the slave position. The master/slave switch of the first flash memory drive in the master position sets the first flash memory drive to transfer data from its flash memory chip to the flash memory chip of the second flash memory drive. The master/slave switch of the second flash memory drive in the slave position sets the second flash memory drive to receive data from the flash memory chip of the first flash memory drive.

The first flash memory drive can include a switch for initiating the transferring of data from the first flash memory drive to the second flash memory drive, or vice versa, when pressed.

The first flash memory drive can also include a female connector and the second flash memory drive can also include a male connector having a configuration that can mate with the female connector.

The invention is also a flash memory drive that includes an enclosure, a flash memory chip disposed in the enclosure, means disposed in the enclosure for controlling the transfer of data to or from the flash memory chip, a female USB connector at least partially disposed within the enclosure, a male USB connector at least partially disposed within the enclosure and configured to mate with another female USB connector for transferring data to or from the flash memory chip under the control of the means for controlling the transfer of data when the male USB connector is mated with the other female USB connector, and means disposed in the enclosure for establishing a wireless communication link for (i) wirelessly transmitting data from the flash memory chip under the control of the means for controlling the transfer data and/or (ii) wirelessly receiving data for storage in the flash memory chip under the control of the means for controlling the transfer data when the male USB connector is not mated with the other female USB connector.

The drive can also include at least one of a battery coupled to provide power to the flash memory chip, the means for controlling the transfer data and the means for establishing a wireless communication link, a switch for initiating the transfer of data to or from the flash memory chip, and a master/slave switch for causing data to be transferred to or from the flash memory chip as a function of the setting of the switch.

Lastly, the invention is a handheld, portable flash memory drive that includes a flash memory chip, means for controlling the transfer of data to or from the flash memory chip, means for establishing a direct radio communication link with another flash memory drive for (i) radio transmitting data from the flash memory chip to said other flash memory drive under the control of the means for controlling the transfer data and/or (ii) radio receiving data for storage in the flash memory chip from said other flash memory drive under the control of the means for controlling the transfer of data, a battery for powering the flash memory chip, the means for controlling the transfer of data and the means for establishing a radio communication link, and an enclosure for housing the flash memory chip, the means for controlling the transfer of data, the means for establishing a radio communication link and the battery.

### BRIEF DESCRIPTION OF THE DRAWINGS

FIG. 1 is an exploded perspective view of a flash memory drive in accordance with a first embodiment of the present invention;

FIG. 2 is an assembled perspective view of the flash memory drive of FIG. 1;

FIG. 3 is a perspective view of two first embodiment flash memory drives interacting physically or wirelessly;

FIG. 4 is a perspective view of the first embodiment flash memory drive interacting with a USB cable having a male connector;

FIG. 5a is an exploded perspective view of a flash memory drive in accordance with a second embodiment of the present invention;

FIG. 5b is an assembled perspective view of the flash memory drive of FIG. 5a;

FIG. 6 is a perspective view of a flash memory device in accordance with a third embodiment of the present invention; and

FIG. 7 is a flow-diagram of a method of transferring information between two flash memory drives joined together either physically or wirelessly.

### DETAILED DESCRIPTION OF THE INVENTION

The present invention will be described with reference to the accompanying figures where like reference numbers correspond to like elements.

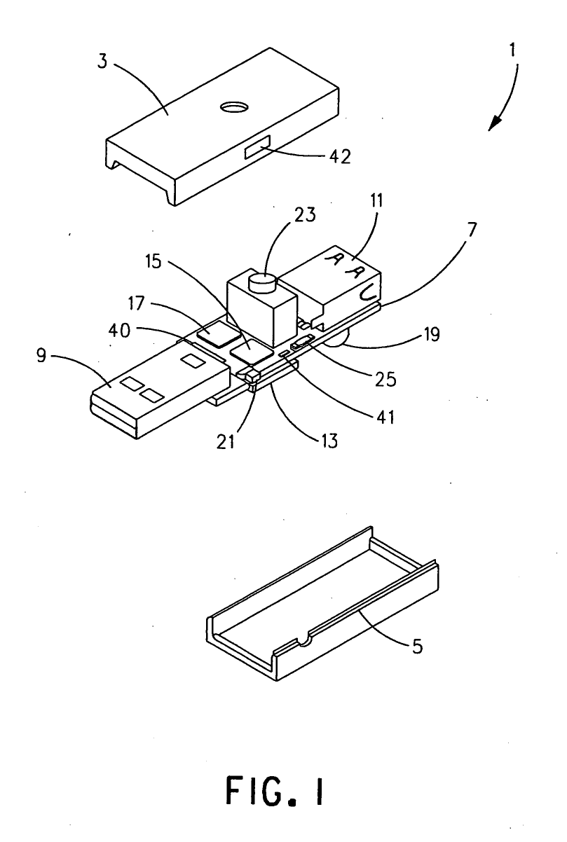

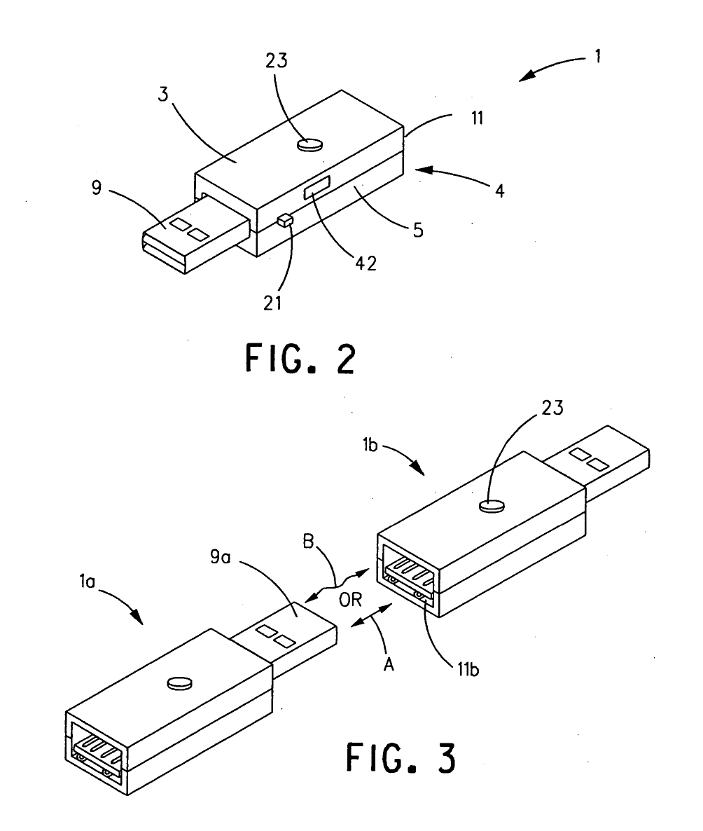

With reference to FIGS. 1 and 2, a flash memory drive 1 includes a top cover 3, a bottom cover 5 and a substrate, such as, without limitation, a printed circuit board 7.

Top cover 3 and bottom cover 5 can mate around printed circuit board 7 to form a protective housing 4. These covers can be made of a variety of materials, such as, without limitation, plastic or metal.

Flash memory drive 1 further includes a male USB connector 9 and a female USB connector 11. Male USB connector 9 and female USB connector 11 are mounted on printed circuit board 7 by soldering, surface mount technology, press fitting or other means of mounting components on printed circuit boards known in the art. Male USB connector 9 is configured to mate with a female USB connector of a desktop computer, laptop computer, palm device, an interface cable, etc. Female USB connector 11 is configured to mate with a male USB connector of another flash memory drive. This other flash memory drive can either be a prior art flash memory drive or a flash memory drive in accordance with the present invention.

One or more flash memory chips 13, a download/copy logic chip 15, a hub logic chip 17 and a battery 19 can be mounted on printed circuit board 7 in a manner known in the art. Hereafter, it will be assumed that only one flash memory chip 13 is present. However, this is not to be construed as limiting the invention. Flash memory chip 13 is configured to store anywhere from 256 kilobytes to 1 gigabyte of data. Download/copy logic chip 15, which is electrically connected to flash memory chip 13, facilitates the transfer of data stored therein to a flash memory chip of another flash memory drive, or vice versa. Hub logic chip 17 facilitates connection of one or both of male USB connector 9 and female USB connector 11 to a universal serial bus having connected thereto one or more other devices, such as, without limitation, a prior art flash memory drive, another flash memory drive in accordance with the present invention, a desktop computer, a laptop computer, a palm device, a printer, a digital camera, a scanner, and the like. Battery 19 provides power to flash memory chip 13, download/copy logic chip 15 and hub logic chip 17 when flash memory drive 1 is not attached to the USB port of an externally powered device, such as a computer, palm device, etc. Battery 19 enables the combination of flash memory chip 13, download/copy logic chip 15 and hub logic chip 17 to transfer data from flash memory chip 13 to the flash memory chip of another flash memory drive, or vice versa, without the use of such an externally powered device. A logic chip (not shown) can be electrically coupled to battery 19 to enable the charging of battery 19 when male USB connector 9 or female USB connector 11 of flash memory drive 1 is connected to an externally powered device. While battery 19 is used in the present embodiment, it is envisioned that flash memory drive 1 may also or alternatively include other power supplies, such as one or more solar cells that can be utilized to power chips 13, 15 and 17 and/or charge battery 19.

Printed circuit board 7 can also include a wireless, radio communication chip 40 and an antenna 41 mounted thereon, with wireless communication chip 40 coupled to download/copy logic chip 15 which can be configured to facilitate the transfer of data between wireless communication chip 40 and flash memory chip 13. Specifically, download/copy logic chip 15 can be configured to transfer data from flash memory chip 13 to wireless communication chip 40 for wireless transmission of said data via antenna 41 utilizing wireless communication protocols known in the art, such as Bluetooth and WiFi. In addition, download/copy logic chip 15 can be configured to store data received by wireless communication chip 40 wirelessly via antenna 41 in flash memory chip 13. If desired, housing 4 can include an opening 42 adjacent antenna 41 to facilitate the passage of radio waves from and to antenna 41.

While download/copy logic chip 15, hub logic chip 17, wireless communication chip 40 and the logic chip for enabling the battery to charge are described above as separate chips, it is envisioned that the function of each of these chips can be incorporated into one or two chips. Accordingly, the number of chips described herein is not to be construed as limiting the invention.

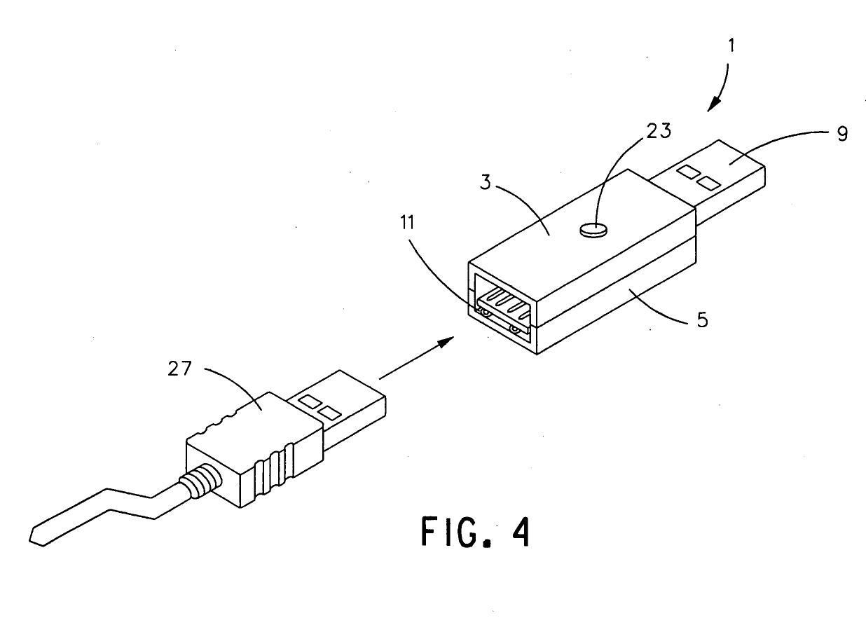

With reference to FIG. 3 and with continuing reference to FIGS. 1 and 2, a first flash memory drive 1a and a second flash memory drive 1b, both in accordance with the present invention, can be physically joined (or mated) together by inserting (see two headed arrow A in FIG. 3) the male USB connector 9a of first flash memory drive 1a to the female USB connector 11b of second flash memory drive 1b for the purpose of transferring or copying data from the flash memory chip of first flash memory drive 1a to the flash memory chip of second flash memory drive 1b, or vice versa, via mated USB connectors 9a and 11b. Also or alternatively, first flash memory drive 1a and second flash memory drive 1b can be wirelessly (communicatively) joined together via a wireless, radio communication link (see two headed arrow B in FIG. 3) established between their respective wireless communication chips 40 and antennas 41 for the purpose of transferring or copying data from the flash memory chip of first flash memory drive 1a to the flash memory chip of second flash memory drive 1b, or vice versa.

Each flash memory drive 1 can include a master/slave switch 21 coupled to download/copy logic chip 15 for setting the flash memory drive as either a master or a slave. In operation, when first flash memory drive 1a and second flash memory drive 1b are joined together, either physically or wirelessly, the flash memory drive set to be the master transfers data from its flash memory chip to the flash memory chip of the flash memory drive set to be the slave. For example, first flash memory drive 1a can be set as the master and second flash memory drive 1b can be set as the slave using each flash memory drive's master/slave switch 21. Hence, when first flash memory drive 1a and second flash memory drive 1b are joined together, either physically or wirelessly, data can be transferred from the flash memory chip of first flash memory drive 1a to the flash memory chip of second flash memory drive 1b.

When flash memory drive 1 in accordance with the present invention is utilized with a conventional, prior art flash memory drive having only a male USB connector and no wireless communication capability, the master/slave switch 21 of flash memory drive 1 can set flash memory drive 1 as the master for transferring data from the flash memory chip of flash memory drive 1 to the flash memory chip of the prior art flash memory drive. Alternatively, the master/slave switch 21 of flash memory drive 1 in accordance with the present invention can set flash memory drive 1 as the slave for transferring data from the flash memory chip of the prior art flash memory drive to the flash memory chip 13 of flash memory drive 1 in accordance with the present invention. Thus, it can be seen that flash memory drive 1 in accordance with the present invention can be used with other flash memory drives 1 in accordance with the present invention or with prior art flash memory drives.

Master slave switch 21 can also include an intermediate position wherein the transfer of data to or from flash memory chip 13 of flash memory drive 1 can be disabled. This intermediate position of master/slave switch 21 avoids the inadvertent transfer of data to or from the flash memory chip 13 of flash memory drive 1.

Desirably, when flash memory drive 1 is physically or wirelessly joined to a computer, a palm device, and the like, the transfer of data to or from flash memory chip 13 can be controlled via the device in a manner known in the art. Thus, desirably, it is only when the master/slave switch 21 sets flash memory drive 1 as the master that flash memory drive 1 is operative for controlling the transfer of data from its flash memory chip 13. This is in contrast to when master/slave switch 21 sets flash memory drive 1 as a slave, wherein flash memory drive 1 enables data to be transferred into its flash memory chip 13 under the control of another flash memory drive in accordance with the present invention, from a prior art flash memory drive or under the control of a computer, palm device, and the like.

A push button switch 23 can be provided on printed circuit board 7 and accessible via top cover 3 to allow for manual activation of the transfer of data between flash memory drives physically or wirelessly joined together. For example, in response to activation of push button switch 23 of first flash memory drive 1a, set as a master by master/slave switch 21, download/copy logic chip 15 of first flash memory drive 1a transfers data from the flash memory chip 13 of flash memory drive 1a to the flash memory chip 13 of either second flash memory drive 1b or a prior art flash memory drive (not shown) joined, either physically or wirelessly, to first flash memory drive 1a. However, the use of push button switch 23 is not to be construed as limiting the invention since it is envisioned that other means can be utilized to cause the transfer of data between flash memory drives. For example, flash memory drive 1 can be responsive to the setting of master/slave switch 21 for transferring data to or from its flash memory chip when flash memory drive 1 is connected to another flash memory drive in accordance with the present invention or a prior art flash memory drive.

Desirably, flash memory drive 1 in accordance with the present invention is configured to detect when either USB connector 9a or 11b is mated with a mating USB connector of another device whereupon data is copied or transferred to or from the flash memory chip 13 of flash memory drive 1 via said mated connectors. Alternatively, when both USB connectors 9a and 11b of flash memory drive 1 are not mated with a mating USB connector of another device, data is copied or transferred to or from the flash memory chip 13 of flash memory drive 1 wirelessly via wireless communication chip 40 and antenna 41 of flash memory drive 1.

Each flash memory drive 1 can also include an optional light emitting diode (LED) 25 that is illuminated when data is being transferred therefrom to either another flash memory drive in accordance with the present invention or a prior art flash memory drive, or vice versa. Housing 4 can include an opening (not shown) adjacent LED 25 for enabling light emitted by LED 25 to be viewed external to housing 4. LED 25 may be selected from any light emitting device suitable for such an application.

With reference to FIG. 4 and with continuing reference to FIGS. 1 and 2, flash memory drive 1 may also be used to maximize the available USB ports on a computer or palm device. Specifically, male USB connector 9 of flash memory drive 1 may be inserted into a USB port of a computer (not shown). Thereafter, female USB connector 11 can accept a male USB connector 27 of a USB cable. This enables peripheral devices, such as cameras, printers, scanners or additional flash memory drives, to utilize the same USB port on a computer as flash memory drive 1.

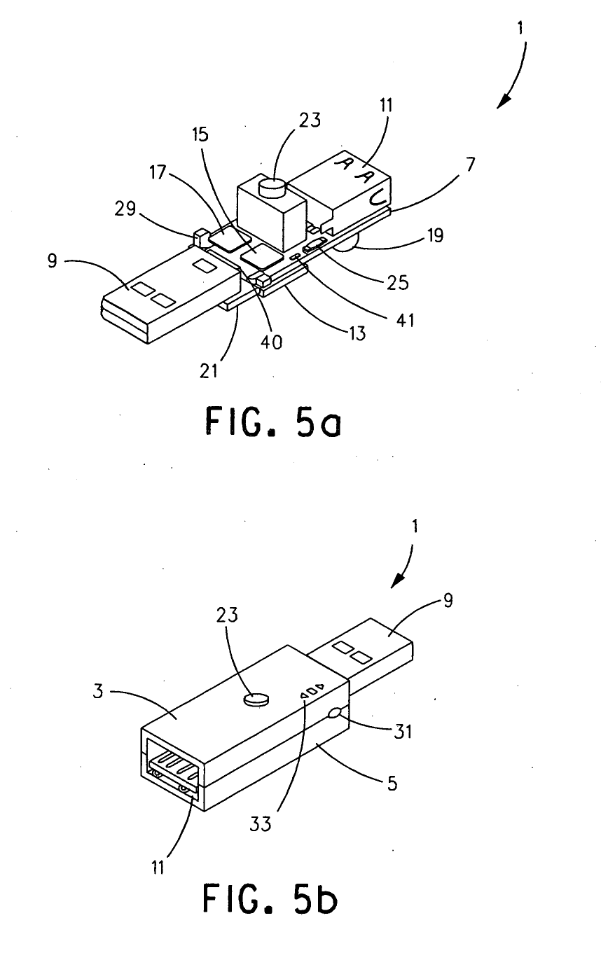

With reference to FIGS. 5a and 5b, a second embodiment of flash memory drive 1 includes a digital audio chip 29 and an output connector 31, such as a headphone jack. Digital audio chip 29 can include a digital signal processor (DSP), an amplifier and a digital-to-analog converter (DAC). The DSP can retrieve digital audio data from flash memory chip 13 and can decode said digital audio data utilizing a suitable decompression algorithm, such as an mp3 or wma decompression algorithm, that undoes the compression of the digital audio data stored in a corresponding compressed format on flash memory chip 13. Then, the DAC converts the decompressed audio data back into an analog audio signal. Finally, the amplifier boosts the strength of the signal and sends it to sound output connector 31. Buttons 33 can be provided on top cover 3 for controlling digital audio chip 29. Buttons 33 perform such functions as playing the digital audio data, stopping, pausing, skipping, rewinding and the like. While push button switch 23 is shown, the function provided by push button switch 23 can be incorporated into one or more buttons 33, whereupon push button switch 23 can be omitted from the embodiment shown in FIGS. 5a and 5b.

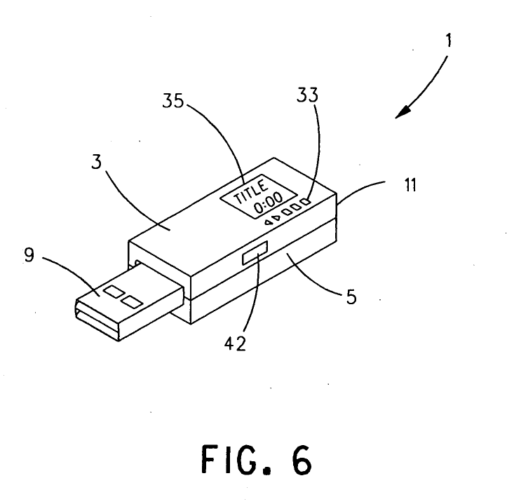

With reference to FIG. 6, a third embodiment of flash memory drive 1 includes a display screen 35 viewable via top cover 3. Display screen 35 can be connected to suitable circuitry mounted on printed circuit board 7 for providing a visual indication of the title of the digital audio data, the time remaining in a song and other useful and desirable information. This embodiment can replace push button 23 and/or master/slave switch 21 with buttons 33. Flash memory drive 1 can be programmed so download/copy logic chip 15 is responsive to the actuation of one or more buttons 33 for setting the device to be a master or a slave. A visual indication of “Master” or “Slave” can be provided on display screen 33. A signal can also be sent to download/copy logic chip 15 to initiate the transfer of data to or from flash memory chip 13 when another one of the buttons 33 is pressed. A visual indication such as “Transfer in Progress” may be provided on display screen 35, thereby obviating the need for LED 25. Display screen 35 can be a liquid crystal display (LCD), a plasma screen or the like.

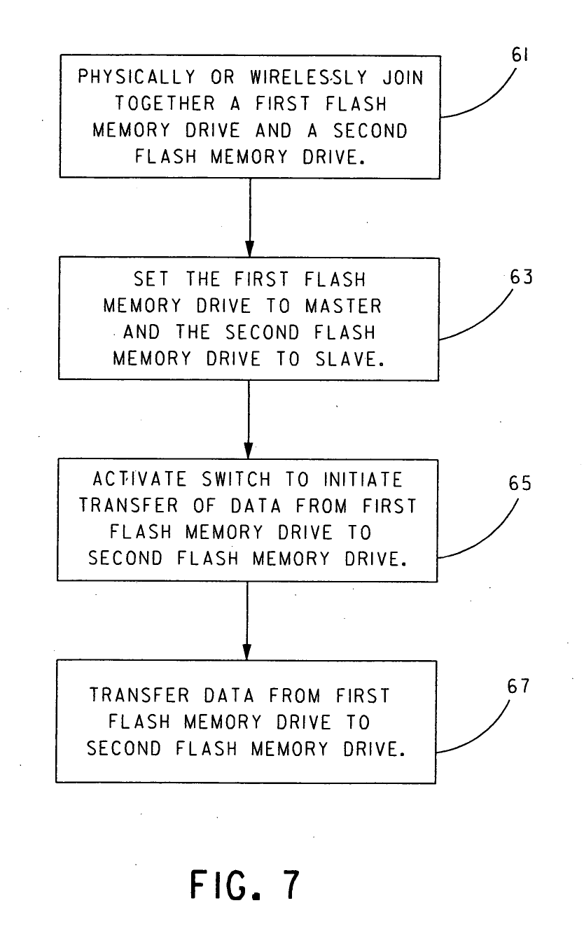

With reference to FIG. 7, the present invention is also a method for transferring data to or from the flash memory chip of a flash memory drive. The method includes step 61 wherein a first flash memory drive and a second flash memory drive are physically or wirelessly joined together. At step 63, the first drive is set to master and the second drive is set to slave using their respective master/slave switches. At step 65, a switch, such as push button switch 23 or one of buttons 33, is activated to initiate the transfer of data from the flash memory chip of the first flash memory drive to the flash memory chip of the second flash memory drive, either wirelessly when the first and second flash memory drives are not physically connected together via mated connectors or via connectors of the first and second flash memory drives when said connectors are mated together. At step 67, the data is transferred from the flash memory chip of the first drive to the flash memory chip of the second drive.

The preceding method is illustrative of the transfer of data between two flash memory drives in accordance with the present invention and is not to be construed as limiting the invention. The transfer of data between a flash memory drive in accordance with the present invention and prior art flash memory drives, computers, palm devices, laptops, and the like is also envisioned. For example, when the male connector of a prior art flash memory drive is inserted into the female connector of a flash memory drive in accordance with the present invention, the master/slave switch of the flash memory drive in accordance with the present invention is set to master for transferring data from the flash memory chip of flash memory drive in accordance with the present invention to the flash memory chip of the prior art flash memory drive, or vice versa. A further example is when a flash memory drive in accordance with the present invention is physically or wirelessly joined to a computer, palm device, and the like, such that the transfer of data to or from the flash memory chip of the flash memory drive in accordance with the present invention can be controlled by the computer, palm device, and the like, in a manner known in the art.

The invention has been described with reference to the preferred embodiments. Obvious modifications and alterations will occur to others upon reading and understanding the preceding detailed description. It is intended that the invention be construed as including all such modifications and alterations insofar as they come within the scope of the appended claims or the equivalents thereof.

The invention claimed is:

1. A flash memory drive comprising:
a flash memory chip for storing data;
a male connector;
a female connector configured to mate with the male connector;
means for controlling the transfer of data to or from the flash memory chip; and
means for establishing a wireless communication link with an external device, wherein:
the female connector is configured to mate with another male connector and the male connector is configured to mate with another female connector;
the male and female connectors are each configured to pass data to and/or from the flash memory chip under the control of the means for controlling the transfer of data when mated to a mating connector; and
the means for establishing a wireless communication link wirelessly transmits data to the external device from the flash memory chip and/or wirelessly receives data from the external device for storage in the flash memory chip under the control of the means for controlling the transfer of data when neither the male connector nor the female connector is mated to a mating connector.

2. The drive of claim 1, further including an enclosure surrounding the flash memory chip, the means for controlling the transfer of data and the means for establishing a wireless communication link.

3. The drive of claim 1, wherein the external device is another flash memory drive.

4. The drive of claim 1, further comprising at least one of:
a battery coupled to provide power to the flash memory chip, the means for controlling the transfer of data and the means for establishing a wireless communication link;
a switch for causing the transfer of data to or from the flash memory chip;
a master/slave switch for setting the drive to transfer data to or from the flash memory chip as a function of the setting of said master/slave switch; and
an LED for indicating that the transfer of data is in progress.

5. The drive of claim 1, further comprising:
means for retrieving digital audio data from the flash memory chip;
means for decoding the retrieved digital audio data;
means for converting the decoded digital audio data to an analog signal; and
an output connector for outputting the analog signal.

6. The drive of claim 5, further comprising:
an enclosure surrounding at least one of the flash memory chip, the means for controlling the transfer of data, the means for establishing a wireless communication link, the means for retrieving digital audio data, the means for decoding the retrieved digital audio data, the means for converting the decoded digital audio data to an analog signal and at least part of the output connector; and
a plurality of buttons accessible via the enclosure for controlling at least one of the means for retrieving digital audio data, the means for decoding the retrieved digital audio data and the means for converting the decoded digital audio data to an analog signal.

7. The drive of claim 6, further comprising a display screen viewable via the enclosure for providing a visual indication of information related to the digital audio data.

8. A method of transferring data from a first flash memory drive having an integrated male connector to a second flash memory drive having an integrated female connector configured to mate with the male connector, wherein each flash memory drive has wireless communication capability, the method comprising:
when the female connector is not mated with the male connector, creating a wireless communication link between the first flash memory drive and the second flash memory drive and wirelessly transferring data from the flash memory chip of the first flash memory drive to the flash memory chip of the second flash memory drive, or vice versa; and
when the female connector is mated with the male connector, transferring data from the flash memory chip of the first flash memory drive to the flash memory chip of the second flash memory drive, or vice versa, via the mated connectors.

9. The method of claim 8, wherein the first flash memory drive includes a master/slave switch set to one of a master position and a slave position and the second flash memory drive includes a master/slave switch set to the other of the master position and the slave position.

10. The method of claim 9, wherein the master/slave switch of the first flash memory drive in the master position sets the first flash memory drive to transfer data from its flash memory chip to the flash memory chip of the second flash memory drive, and the master/slave switch of the second flash memory drive in the slave position sets the second flash memory drive to receive data from the flash memory chip of the first flash memory drive.

11. The method of claim 8, wherein at least the first flash memory drive includes a switch for initiating the transferring of data from the first flash memory drive to the second flash memory drive, or vice versa, when pressed.

12. The method of claim 8, wherein the first flash memory drive includes a female connector and the second flash memory drive includes a male connector having a configuration that can mate with the female connector.

13. A flash memory drive comprising:
an enclosure;
a flash memory chip disposed in the enclosure;
means disposed in the enclosure for controlling the transfer of data to or from the flash memory chip;
a female USB connector at least partially disposed within the enclosure;
a male USB connector at least partially disposed within the enclosure and configured to mate with another female USB connector for transferring data to or from the flash memory chip under the control of the means for controlling the transfer of data when the male USB connector is mated with the other female USB connector; and
means disposed in the enclosure for establishing a wireless communication link for (i) wirelessly transmitting data from the flash memory chip under the control of the means for controlling the transfer data and/or (ii) wirelessly receiving data for storage in the flash memory chip under the control of the means for controlling the transfer of data when the male USB connector is not mated with the other female USB connector.

14. The drive of claim 13, further comprising at least one of:
a battery coupled to provide power to the flash memory chip, the means for controlling the transfer of data and the means for establishing a wireless communication link;
a switch for initiating the transfer of data to or from the flash memory chip; and
a master/slave switch for causing data to be transferred to or from the flash memory chip as a function of the setting of the switch.

15. A handheld, portable flash memory drive comprising:
a flash memory chip;
means for controlling the transfer of data to or from the flash memory chip;
means configured for establishing a direct radio communication link with another flash memory drive for (i) radio transmitting data from the flash memory chip to said other flash memory drive under the control of the means for controlling the transfer data and/or (ii) radio receiving data for storage in the flash memory chip from said other flash memory drive under the control of the means for controlling the transfer data;
a battery for powering the flash memory chip, the means for controlling the transfer of data and the means for establishing a radio communication link; and
an enclosure for housing the flash memory chip, the means for controlling the transfer of data, the means for establishing a radio communication link and the battery.
